(19) United States
(12) Patent Application Publication
(10) Pub. No.: US 2024/0364594 A1
(43) Pub. Date: Oct. 31, 2024

(54) System and Method for Automatic Labeling of Hosts for Cluster Implementation

(71) Applicant: Dell Products L.P., Round Rock, TX (US)

(72) Inventors: Sudhir Vittal Shetty, Cedar Park, TX (US); Vijayasimha Reddy Naga, Georgetown, TX (US); Barry Alan Feigenbaum, Austin, TX (US)

(73) Assignee: Dell Products L.P., Round Rock, TX (US)

(21) Appl. No.: 18/141,303

(22) Filed: Apr. 28, 2023

(51) Int. Cl. H04L 41/12; H04L 41/0894

(52) U.S. Cl. CPC H04L 41/12; H04L 41/0894

(57) ABSTRACT

A system, method, and computer-readable medium for defining solutions to devices in a data center. A solutions platform receives solutions meta data that includes solutions files and a label catalog. The label catalog includes labels that define pre-requisite criteria for devices that can receive solution files. The devices in the data center are discovered, and provisioning of solution files is performed on devices that meet pre-requisite criteria of particular labels. Devices are associated with labels for which pre-requisite criteria is met and devices are associated with the labels.

### BACKGROUND OF THE INVENTION

### Field of the Invention

The present invention relates to information handling systems. More specifically, embodiments of the invention provide a system, method, and computer-readable medium for defining the solutions or applications, such as those for a cluster (e.g., Kubernetes), where the solutions are provided to information handling systems.

### Description of the Related Art

As the value and use of information continues to increase, individuals and businesses seek additional ways to process and store information. One option available to users is information handling systems. Information handling systems include personal computers (PC), server computers, desktop computers, notebooks, laptops, etc. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

To support such information handling systems, the use of container based applications, such as Kubernetes implemented applications can be used. In particular, for data centers employing multiple information handling systems, such as servers and other devices, employ the use of Kubernetes-based clusters. Such clusters span across multiple servers/devices. The clusters have specific solutions which have unique requirements for servers/devices. Requirements can be based for example on inventory, configuration, dynamic telemetry from the server, etc. During automated cluster implementation (e.g., deployment, updating, reconfiguration, etc.) and provisioning of the solution, there is no intelligence as to which servers/devices can host the solution cluster, and the cluster application containers. Provisioning typically requires manual intervention to ensure correct placement of the solution/application on the servers/devices.

### SUMMARY OF THE INVENTION

A computer-implementable method, system and computer-readable storage medium for defining solutions to devices in a data center comprising receiving solutions meta data by a solution platform, wherein the solutions meta data includes solutions files and label catalog of labels that define pre-requisite criteria for devices that can receive solution files; discovering by a discovery component of the solution platform the devices in the data center;—provisioning by a provisioning component of the solution platform particular solution files to devices that meet pre-requisite criteria of particular labels; and associating devices that meet pre-requisite criteria of particular labels with the labels.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of a system for implementing the processes of the described invention;

FIG. 2 are label catalog and solutions files for implementing the processes of the described invention;

FIG. 3 is a diagram of provisioning of Kubernetes clusters on servers/devices;

FIG. 4 is generalized flowchart for defining labels and solutions provided to servers/devices deployed in a customer data center;

FIG. 5 is a generalized flowchart for defining and provisioning solutions to servers/devices in a customer data center; and

FIG. 6 is a generalized illustration of an information handling system that can be used to implement the system and method of the present invention.

### DETAILED DESCRIPTION

Described herein are implementations that provide for defining the solutions or applications, such as those for a cluster (e.g., Kubernetes), where the solutions are provided to information handling systems, such as servers/devices deployed in a customer data center. The defined solutions are provided labels that define pre-requisite criteria, and placement of the solution or applications that match the pre-requisite criteria.

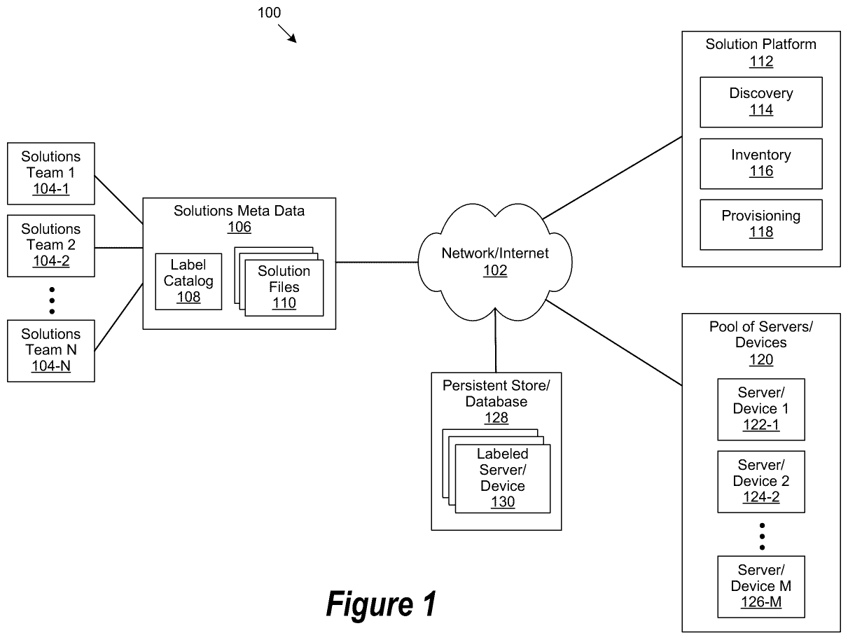

FIG. 1 shows a system 100 for implementing the processes of the described invention. The system includes a network 102, where network 102 can include one or more wired and wireless networks, including the Internet. Network 102 is likewise accessible by the elements of system 100.

A provider, such as a provider of resources for a customer supports services to the customer. The customer can employ the provider resources at a “on premise” site. Resources can include various devices, such as network servers, etc. The provider can provide the services through a cloud service, site, etc. connected to network 102 and accessible by the customer data center and its resources.

The system 100 includes solutions teams 104 that include information handling systems accessed by developers, which create solutions for customer resources or servers/devices. In particular, labels are created and define for example, pre-requisite criteria for the serves/devices during cluster deployment. Pre-requisite criteria can include CPU speed, memory requirements, storage requirements, etc. Labels can also define upgrade and replacement of servers/devices, such as when server/device fails, and which server/device can take up the workload of the failed server/device.

Implementations provide for a Kubernetes platform to use the data in the labels to provision the clusters. Labels can also be used to instruct other platforms, and provide data as to operations, defining resources, etc.

Solutions meta data 106 is provided by the solutions teams 104. Implementations provide solutions meta data 106 to a label catalog 108 with solution entries from each of the solutions teams 104. Solutions meta data 106 can further include solutions files 110 provided by each of the solutions teams 104. Solutions files 110 can be structured as YAML files, or other data file types. Examples of the label 108 and solutions files 110 are further shown and described below.

Solutions meta data 106 may be located in a provider service, such as a cloud service. Solutions meta data is accessed through network 102 by other elements of the system 100.

Implementations provide for the system 100 to include a solution platform 112. The solution platform 112 can be implemented on premise of the customer, implemented on a cloud service, or implemented on another site. The solution platform 112 can be provided by a provider of the resources (e.g., servers/devices) of a customer data center.

Various implementations provide for the solution platform 112 to include a discovery component 114. The discovery component 114 discovers resources, such as servers/devices of the customer data center. Solution platform 112 can include an inventory component 116. The inventory component 116 downloads the label catalog 108, and interprets data/information in the label catalog 108. Solution platform 112 can also include a provisioning component 118. The provisioning component 118 downloads the solution files 110, and interprets data/information in the solutions files 110. The provisioning component 118 allows for provisioning or updating of hardware configuration, operating system (OS) deployment/updating, and solution deployment/updating to the serves/devices of the customer data center. Discover component 114, inventory component 116 and provisioning component 118 are further described below.

Implementations provide for the solution platform 112 to include a Kubernetes API server (not shown), a unified controller (not shown), CMO/BMO controllers (not shown) and label manager (not shown). The Kubernetes API server is used when a solution file 110 invokes a Kubernetes API for cluster provisioning. The Kubernetes API server notifies the unified controller. The unified controller triggers discovery by the CMO/BMO controllers, triggers cluster deployment, and triggers application deployment. CMO/BMO controllers discovers a pool of servers/devices 120, persists inventory in the database, as further discussed herein, deploys a Kubernetes cluster based on pre-requisite criteria, and triggers application deployment on nodes based on prerequisite criteria. The label manager retrieves the latest label catalog 108, and annotates server/devices of pool of servers/devices 120 with correct labels by evaluating rules in the label catalog 108 and comparing the rules with inventory of the pool of servers/devices 120.

System 100 includes the pool of server/devices 120, that includes multiple servers/devices 122-1 to 122-M. The pool of servers/devices 120 can be located on premise at a customer site and be part of a customer data center. The servers/devices 122 are connected to the solution platform 112. The solution platform performs operations on the servers/devices 122, including deployment/updating solutions files 110 using the label catalog 108.

Implementations provide for the system 100 to include a persistent store/database 128. The persistent store/database 128 includes files of servers/devices 122 that have been labeled, or labeled server/device files 130, which identify server/devices 122 that have received and have applied the solutions files 110 of particular solutions teams 104. In various implementations, the discovery component 114 persists the servers/devices 122 as labeled server/device files 130 to persistent store/database 128. Implementations provide for the inventory component 116 to label the servers/devices 122 as labeled server/device files 130.

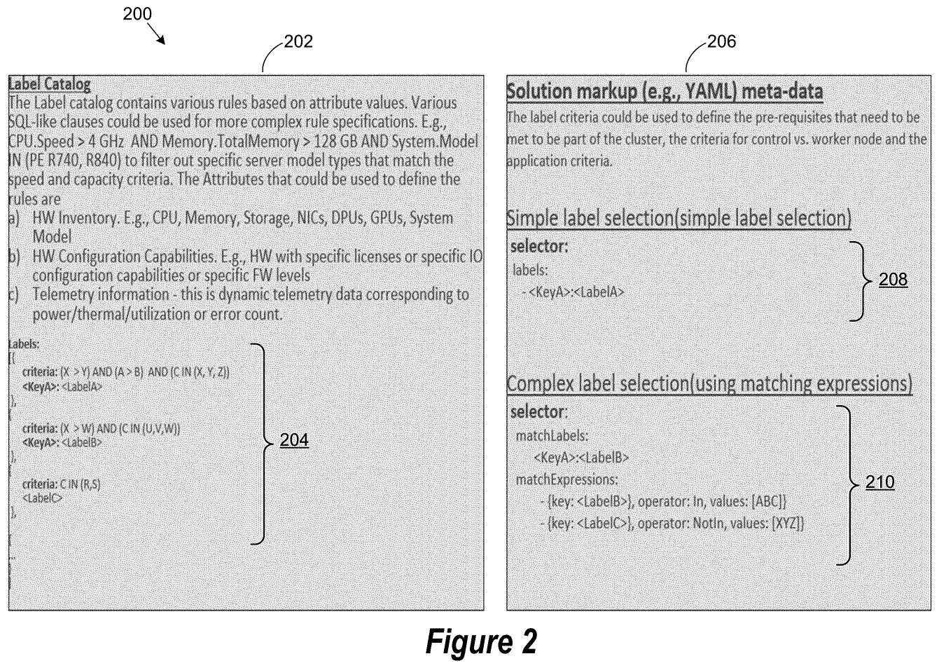

FIG. 2 shows examples 200 of a label catalog 202 and solutions files 204. Label catalog 202 is an example of label catalog 108 and solutions files 204 is an example of solutions files 110 described above. As discussed above, the label catalog 202 and solutions files 210 can be included as solutions meta data 106.

The label catalog 202 can include various rules based on attribute values. Clauses (e.g., SQL-like clauses) can be used for complex rule specifications, such as defining CPU speed, memory, and to filtering out particular server/device models. Examples of attributes that are used to define rules include hardware inventory, hardware configuration capabilities, dynamic telemetry information received from server/devices. Example of label information is shown as labels 206.

The solutions files 204 can include pre-requisites for servers/devices 122, such as label criteria to define what servers/devices 122 need to be part of a cluster, for a server/device to be a control or a worker node in the cluster, and application criteria. An example of simple label selection is shown as selector 208. An example of a more complex label selection is shown as selector 210.

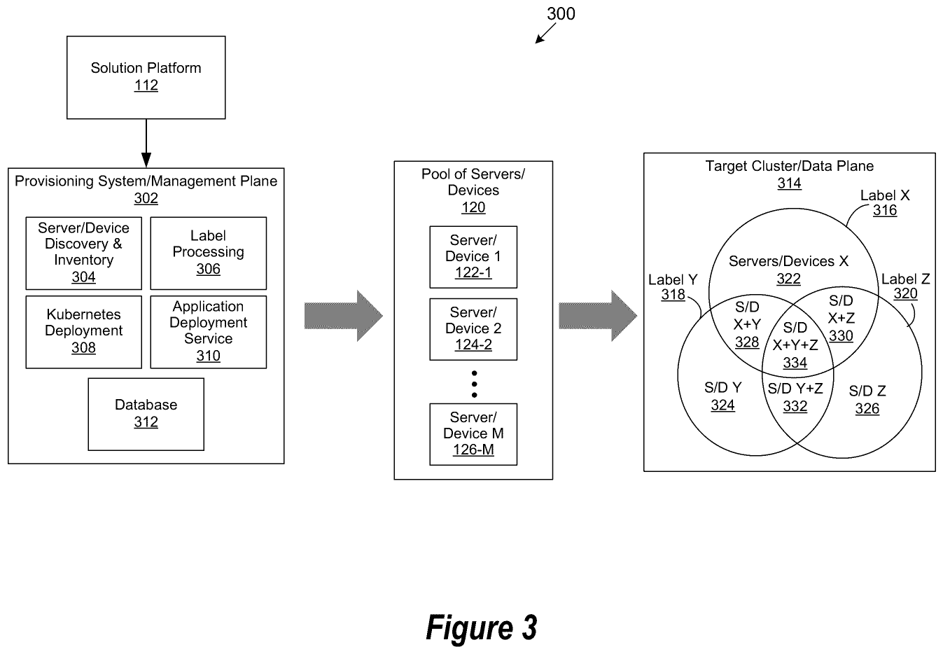

FIG. 3 shows provisioning of Kubernetes clusters on servers/devices. Various implementations make use of Kubernetes container applications and clusters. Kubernetes makes use of a data plane that houses and transports application and data traffic, a control plane that configures rules for the data plane, and a management plane that sets guardrails for data and control planes.

The solutions platform 112 provides data/information to a provisioning system/management plane 302. In particular, provisioning system/management plane 302 is used to bootstrap Kubernetes clusters. In implementations the provisioning system/management plane 302 includes a server/device discovery & inventory component 304 similar to discovery component 114 and inventory component 116. The provisioning system/management plane 302 includes a labeling processing component 306 similar to other components described herein. A Kubernetes deployment component 308 deploys Kubernetes clusters. An application deployment service 310 deploys applications. A database 312 can also be included in provisioning system/management plane 302. The provisioning system/management plane 302 applies/bootstraps Kubernetes clusters to pool of servers/devices 120.

A target cluster/data plane 314 shows a Venn diagram of servers/devices in which particular labels are applied. In this example, the applied labels to pool of servers/devices 120 are label X 316, label Y 318, and label Z 320. The servers/devices to which label X 316 is applied to is represented as servers/devices X 322. The servers/devices to which label Y 318 is applied to is represented as servers/devices Y 324. The servers/devices to which label Z 320 is applied to is represented as servers/devices Z 326. The servers/devices to which label X 316 and label Y 318 are applied to is represented as servers/devices X+Y 328. The servers/devices to which label X 316 and label Z 320 are applied to is represented as servers/devices X+Z 330. The servers/devices to which label Y 318 and label Z 320 are applied to is represented as servers/devices Y+Z 332. The servers/devices to which label X 316, label Y 318 and label Z 320 are applied to is represented as servers/devices X+Y+Z 334.

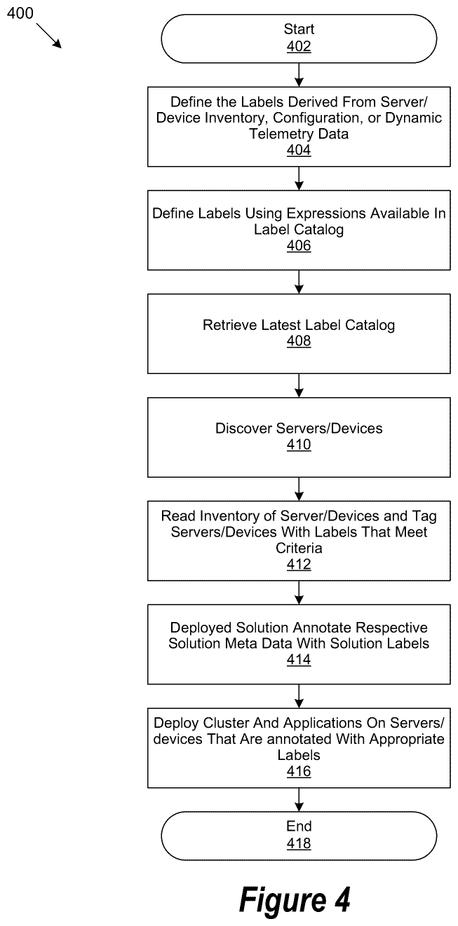

FIG. 4 is a generalized flowchart 400 for defining the solutions or applications, such as those for a Kubernetes cluster, where the solutions are provided to servers/devices deployed in a customer data center. The defined solutions are provided labels that define pre-requisite criteria, and placement of the solution or applications that match the pre-requisite criteria. The order in which the method is described is not intended to be construed as a limitation, and any number of the described method steps may be combined in any order to implement the method, or alternate method. Additionally, individual steps may be deleted from the method without departing from the spirit and scope of the subject matter described herein. Furthermore, the method may be implemented in any suitable hardware, software, firmware, or a combination thereof, without departing from the scope of the invention.

At step 402, the process 400 starts. At step 404, solution teams 104 define labels that are derived from server/device inventory, configuration, or dynamic telemetry data (e.g., power/thermal/utilization/error metrics). For example, a solution team may desire a certain minimum of CPU speed, specific HW accelerators, DPUs, storage capacity, etc. as pre-requisites of server/device hardware. Also, for example, labels can be used to define and capture topology connectivity in a data center (e.g., is the server/device connected to specific networks/storage devices), and fault domains that may exist in their data center environment (e.g., if you want to deploy the cluster across multiple fault domains corresponding to different power grids).

At step 406, the labels are defined using complex expressions that are available in label catalog 108. Each solution team 104 can add additional labels corresponding to the solution requirements to define various criteria for server selection for cluster deployment or for solution application deployment.

At step 408, the latest label catalog 108 is retrieved from solutions meta data 106. At step 410, the servers/devices 122 of the datacenter are discovered.

At step 412 the inventory of discovered servers/devices 122 is read and automatically tags with labels the servers/devices 122 that meet pre-requisite criteria. The pre-requisite criteria is evaluated for labels, and the appropriate servers/devices 122 meeting the pre-requisite criteria are tagged with the appropriate label. Examples of labels can include “SolutionReady,” “AIMLOPsReady,” “DBReady,” etc.

At 414, deployed solutions will annotate their respective solution meta-data file or solution files 110, such as a YAML file, with the solution labels. The solution labels can be used to pre-qualify nodes that qualify to be part of a Kubernetes cluster, distinguish between worker nodes and control plane nodes and for selective targeting of the solution services/containers (Kubernetes container) on specific nodes. For example, the Kubernetes cluster can be deployed on nodes that are tagged as “SolutionReady” and have specific persistent solution software services deployed on nodes that are “DBReady” or AI/ML solution software on “AIMLOPsReady” nodes.

At step 416, Kubernetes clusters and applications are deployed to servers/devices 122 annotated with the appropriate labels. Kubernetes technology can be used to leverage such label matching.

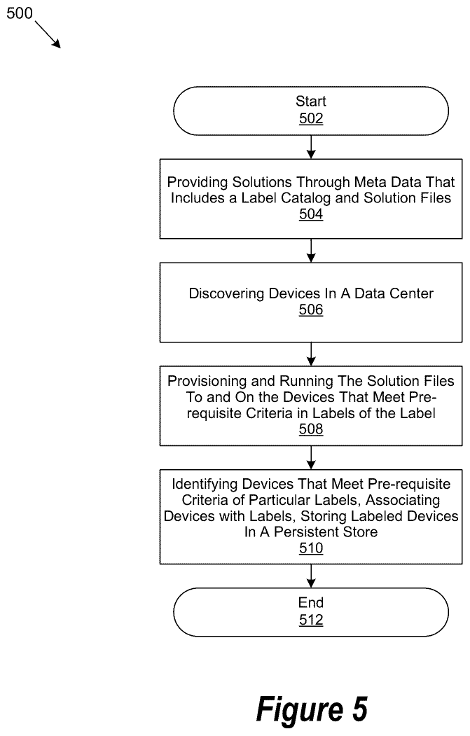

FIG. 5 is a generalized flowchart 500 for defining solutions to servers/devices in a data center. The order in which the method is described is not intended to be construed as a limitation, and any number of the described method steps may be combined in any order to implement the method, or alternate method. Additionally, individual steps may be deleted from the method without departing from the spirit and scope of the subject matter described herein. Furthermore, the method may be implemented in any suitable hardware, software, firmware, or a combination thereof, without departing from the scope of the invention.

At step 502, the process 500 starts. At step 504, solutions meta data 106 is provided to and consumed by a solution platform 112. The solutions meta data 106 includes the label catalog 108 and solutions files 110. Label catalog 108 includes labels that provide pre-requisite criteria of servers/devices. The pre-requisite criteria defines which servers/devices 120 can receive particular solutions files 110.

At step 506, discovery component 114 of the solutions platform discovers the servers/devices 120. At step 508, the provisioning component 118 provisions particular solutions 110 to servers/devices 120 that meet pre-requisite criteria of particular labels in the label catalog 108.

At step 510, servers/devices that meet pre-requisite criteria of particular labels are associated with the labels. Data referencing the labeled devices are stored in persistent store/data base 132. At step 512, the process 500 ends.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a microphone, keyboard, a video display, a mouse, etc. The information handling system may also include one or more buses operable to transmit communications between the various hardware components.

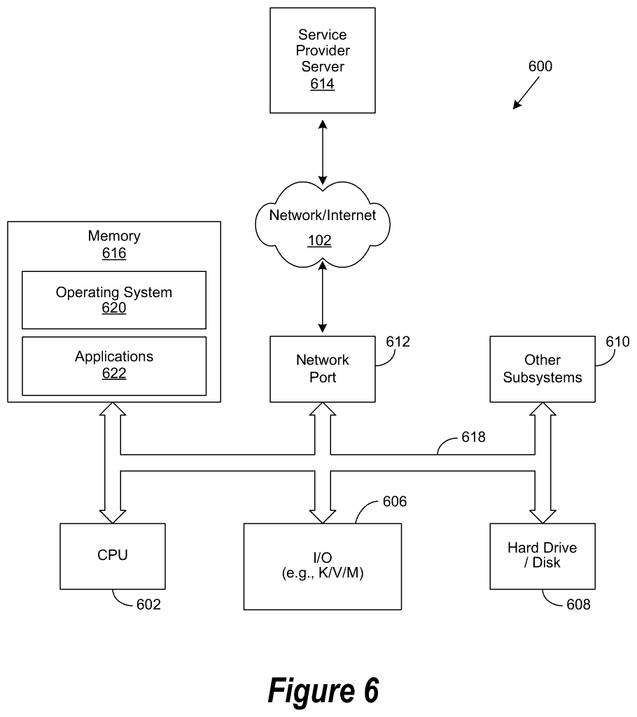

FIG. 6 is a generalized illustration of an information handling system 600 that can be used to implement the system and method of the present invention. The information handling system 600 can be configured for example as a laptop computer, desktop computer, network server, etc. In particular, the information handling system 600 can be information handling systems used by solutions teams 104. Information handling system 600 can also be servers/devices 122, and computing devices of services described herein.

The information handling system 600 includes a processor (e.g., central processor unit or “CPU”) 602, input/output (I/O) devices 604, such as a microphone, a keyboard, a video/display, a mouse, and associated controllers (e.g., K/V/M).

The information handling system 600 includes a hard drive or disk storage 608, and various other subsystems 610. In various embodiments, the information handling system 600 also includes network port 612 operable to connect to the network 102 as described in FIG. 1. As discussed, network 102 can include one or more wired and wireless networks, including the Internet. Network 102 is likewise accessible by a service provider server 614.

The information handling system 600 likewise includes system memory 616, which is interconnected to the foregoing via one or more buses 618. System memory 616 can be implemented as hardware, firmware, software, or a combination of such. System memory 616 further includes an operating system (OS) 620. Embodiments provide for the system memory 616 to include applications 622.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object-oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

Skilled practitioners of the art will recognize that many such embodiments are possible, and the foregoing is not intended to limit the spirit, scope or intent of the invention. Consequently, the invention is intended to be limited only by the spirit and scope of the appended claims, giving full cognizance to equivalents in all respects.

1. A computer-implementable method for defining solutions to server computers in a data center comprising:
receiving solutions meta data by a solution platform, wherein the solutions meta data includes solutions files and label catalog of labels that define pre-requisite criteria for server computers that can receive solution files, wherein the pre-requisite criteria include CPU speed, memory, and storage requirements;
discovering by a discovery component of the solution platform the server computers in the data center;
provisioning by a provisioning component of the solution platform particular solution files to server computers that meet pre-requisite criteria of particular labels;
associating server computers that meet pre-requisite criteria of particular labels with the labels; and
persisting to a store, server computers that have applied solutions files.

2. The method of claim 1, wherein the solutions are applications for Kubernetes clusters.

3. The method of claim 1, wherein the defining solutions is used for deployment of, upgrading, or reconfiguring the server computers in the data center.

4. The method of claim 1, wherein the label catalog includes rules based on attribute values and implements clauses for rule specification, wherein attribute values are based on one or more of server computer inventory, server computer configuration capabilities, dynamic telemetry information.

5. The method of claim 1, wherein solutions platform provides information to a Kubernetes management plane that performs the discovery and inventory of server computers, and application deployment.

6. The method of claim 1, wherein labels are used to define and capture topology connectivity of the server computers in the data center.

7. The method of claim 1, wherein the solution platform is implemented as a cloud service.

8. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations for defining solutions to server computers in a data center executable by the processor and configured for:
receiving solutions meta data by a solution platform, wherein the solutions meta data includes solutions files and label catalog of labels that define pre-requisite criteria for server computers that can receive solution files;
discovering by a discovery component of the solution platform the server computers in the data center;
provisioning by a provisioning component of the solution platform particular solution files to server computers that meet pre-requisite criteria of particular labels;
associating server computers that meet pre-requisite criteria of particular labels with the labels; and
persisting to a store, server computers that have applied solutions files.

9. The system of claim 8, wherein the solutions are applications for Kubernetes clusters.

10. The system of claim 8, wherein the defining solutions is used for deployment of, upgrading, or reconfiguring the server computers in the data center.

11. The system of claim 8, wherein the label catalog includes rules based on attribute values and implements clauses for rule specification, wherein attribute values are based on one or more of server computer inventory, server computer configuration capabilities, dynamic telemetry information.

12. The system of claim 8, wherein solutions platform provides information to a Kubernetes management plane that performs the discovery and inventory of server computers, and application deployment.

13. The system of claim 8, wherein labels are used to define and capture topology connectivity of the server computers in the data center.

14. The system of claim 8, wherein the solution platform is implemented as a cloud service.

15. A non-transitory, computer-readable storage medium embodying computer program code for defining solutions to server computers in a data center, the computer program code comprising computer executable instructions configured for:
receiving solutions meta data by a solution platform, wherein the solutions meta data includes solutions files and label catalog of labels that define pre-requisite criteria for server computers that can receive solution files;
discovering by a discovery component of the solution platform the server computers in the data center;
provisioning by a provisioning component of the solution platform particular solution files to server computers that meet pre-requisite criteria of particular labels;
associating server computers that meet pre-requisite criteria of particular labels with the labels; and
persisting to a store, server computers that have applied solutions files.

16. The non-transitory, computer-readable storage medium of claim 15, wherein the solutions are applications for Kubernetes clusters.

17. The non-transitory, computer-readable storage medium of claim 15, wherein the defining solutions is used for deployment of, upgrading, or reconfiguring the server computers in the data center.

18. The non-transitory, computer-readable storage medium of claim 15, wherein the label catalog includes rules based on attribute values and implements clauses for rule specification, wherein attribute values are based on one or more of server computer, server computer configuration capabilities, dynamic telemetry information.

19. The non-transitory, computer-readable storage medium of claim 15, wherein solutions platform provides information to a Kubernetes management plane that performs the discovery and inventory of server computers, and application deployment.

20. The non-transitory, computer-readable storage medium of claim 15, wherein labels are used to define and capture topology connectivity of the server computers in the data center.
